(19) United States
(12) Patent Application Publication
(10) Pub. No.: US 2013/0239005 A1
(43) Pub. Date: Sep. 12, 2013

(54) TECHNIQUES FOR REMOTE PRESENCE SUBSCRIPTION

(71) Applicants: Ajay Soni, Redmond, WA (US); Srividya Mohan, Redmond, WA (US); Stephane Taine, Issaquah, WA (US); Adarsh Khare, Issaquah, WA (US); Krishnamurthy Ganesan, Redmond, WA (US)

(72) Inventors: Ajay Soni, Redmond, WA (US); Srividya Mohan, Redmond, WA (US); Stephane Taine, Issaquah, WA (US); Adarsh Khare, Issaquah, WA (US); Krishnamurthy Ganesan, Redmond, WA (US)

(73) Assignee: MICROSOFT CORPORATION, Redmond, WA (US)

(21) Appl. No.: 13/413,494

(22) Filed: Mar. 6, 2012

(51) Int. Cl. G06F 3/01

(52) U.S. Cl. 715/738

(57) ABSTRACT

Techniques for remote presence subscription are described. In an embodiment, a technique may include presenting a view interface to a client, where the client user may select what kind of presence information, and for whom, they would like to receive. The techniques may further comprise receiving a selection of presence data through the view interface from the client; creating a view from the selection at a web service; translating the view into a request having a protocol useable by a presence server to retrieve information for the view; requesting and receiving the information for the view using the request; and providing the information for the view to the client. Other embodiments are described and claimed.

### BACKGROUND

Users who spend time on the Internet or other communication networks may be able to provide their presence information to others. Presence information may be provided from a variety of applications, such as through social media sites, chat applications, instant messaging applications, Internet relay chat applications, and so forth. The providers of the presence information, e.g. the presence servers that support the applications, may use a variety of protocols in responding to requests for presence information and providing the presence information. Servers that request and retrieve presence information on behalf of a client application may be limited in the number of connections the servers may have to presence servers. Further, some client applications request presence information that may change frequently, while others may request presence information that rarely changes. It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to techniques for remote presence subscription. Some embodiments are particularly directed to techniques to providing a customizable subscription to another's presence information where the person, type of presence information and duration of the subscription may be customized. In one embodiment, for example, a technique may include presenting a view interface to a client, where the client user may select what kind of presence information, and for whom, they would like to receive. The techniques may further comprise receiving a selection of presence data through the view interface from the client; creating a view from the selection at a web service; translating the view into a request having a protocol useable by a presence server to retrieve information for the view; requesting and receiving the information for the view using the request; and providing the information for the view to the client. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a system for remote presence subscription.

FIG. 2 illustrates an embodiment of a web services server to provide remote presence subscription.

FIG. 3 illustrates an embodiment of a view manager to provide remote presence subscription.

FIG. 4 illustrates an embodiment of a view interface.

FIG. 5 illustrates an embodiment of a logic flow to create and service a remote presence subscription.

FIG. 6 illustrates an embodiment of a logic flow to aggregate views.

FIG. 7 illustrates an embodiment of a computing architecture.

FIG. 8 illustrates an embodiment of a communications architecture.

### DETAILED DESCRIPTION

A user of a communication-enabled application may wish to watch the presence of remote users in a communication space. The communication space may include, for example, a unified communications space, an internal network, an external network, the Internet, and so forth. A communication-enabled application may include, for example, an instant message application, a chat application, an Internet relay chat application, a social media application, chat rooms in a web browser application, collaboration software, and so forth. Presence information may include whether a user is currently logged in; a status of a logged-in user, e.g. busy, available, or away; a location; contact information; an instant message availability; a video chat availability and so forth. A user may wish to watch one remote user's presence information, for example, a friend, indefinitely, but may want to watch another remote user's presence, for example, a meeting co-participant, for a shorter limited period. Conventional communication-enabled applications may provide a way to change the individuals whose presence on a user's wants to watch, but typically may not be able to customize anything else about what presence information is monitored or for how long. Further, a conventional communication-enabled application may only allow one configuration of watched presence information per client. That is, if a user wishes to use the same application to watch two separate sets of presence information, that is not conventionally possible.

To solve these and other limitations, various embodiments are directed to techniques for remote presence subscription. In an embodiment, a technique may include presenting a view interface to a client that allows a user of the client to customize which people to watch, what kind of presence information to retrieve and for how long to watch a person. The technique may further include receiving a selection of presence data through the view interface from the client, and creating a view from the selection at a web service. A view may be a data object that indicates the selections made by the user. The technique may further include translating the view into a protocol useable by a presence server to retrieve information for the view; requesting and receiving the information for the view using the protocol; and providing the information for the view to the client. The client may then display the presence information described in the view. The client may further create multiple views. As a result, the embodiments can improve efficiency and user experience of tracking remote users' presence information.

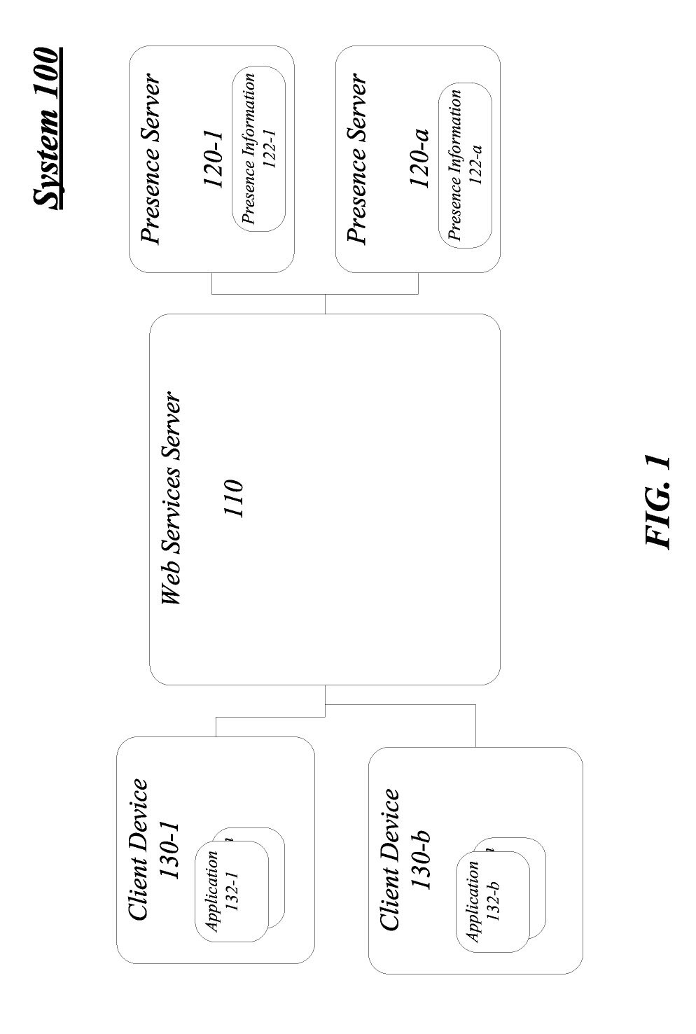

FIG. 1 illustrates an embodiment of a system 100 for remote presence subscription. In one embodiment, for example, the system 100 may comprise a computer-implemented system 100 having multiple components, such as a web-service server 110, a presence server 120, and a client 130. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented with one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

In various embodiments, the system 100 may comprise a web services server 110. Web services server 110, also referred to herein as WSS 110, may be one or more server devices that receive requests for data and/or services from client devices, such as client device 130. One example of a WSS 110 is EXCHANGE SERVER from MICROSOFT® CORP. of Redmond, Wash., USA. The embodiments are not limited to this example. WSS 110 may generally provide services such as email services, contact management services, calendar services, document sharing services, presence information services, services through a web interface, collaboration services, and so forth.

In an embodiment, WSS 110 may be implemented with a cloud computing model. In a cloud computing model, applications and services may be provided as though the applications and data were on a local device, without having to install the applications and/or store the data on a local device. However, the applications and/or data storage may be implemented across many devices, servers, and data stores, accessible over a communication interface from a local device. In a cloud computing model, WSS 110 may be physically embodied on one or more servers, and in one or more physical locations. WSS 110 may be a sub-component of a larger cloud computing implementation of a group of services. Regardless of physical configuration, WSS 110 may appear, logically, as one device or system to external entities, such as client device 130.

In an embodiment, the system 100 may comprise one or more presence servers, such as presence server 120-1, and 120-a, where a represents a positive integer. A presence server 120 may include one or more server devices that provide, at least, presence information 122 about a set of users on request. Examples of a presence server 120 may include without limitation LYNC®, SHAREPOINT®, WINDOWS LIVE®, and EXCHANGE SERVER, all from MICROSOFT® CORP. Different presence servers may respond to different protocols. A request for presence information 122-1 from presence server 120-1 may therefore need to be in a different format than a request for presence information 122-a from presence server 120-a, when presence server 120-1 and 120-a follow different protocols.

In various embodiments, the system 100 may comprise one or more client devices, such as client device 130-1 and 130-b, where b represents a positive integer. A client device 130 may include any electronic device capable of communicating information with WSS 110. The communications may include, for example, configuring a view at an interface provided by WSS 110, and receiving presence information 122 via WSS 110. A client device 130 may include one or more applications 132 that may communicate with WSS 110 to receive or send data, and perform various functions. Such an application may include a communication-enabled application, an e-mail client application, a calendar application, a contact management application, a word processing application, a web browser, and so forth.

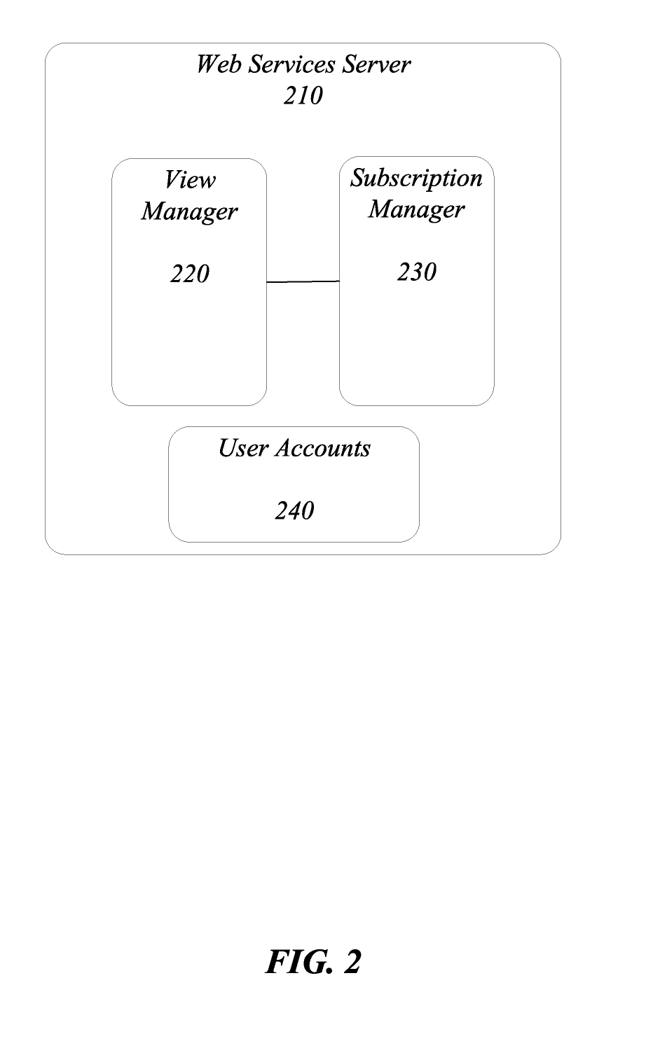

FIG. 2 illustrates an embodiment of a web services server 200 to provide remote presence subscription. Web services server 200 may be a representative embodiment of web services server 110. In various embodiments, web services server 200 may include a view manager 220 and a subscription manager 230 to provide remote presence subscription services. Web services server 200 may be implemented with more or other components and are not limited to this example.

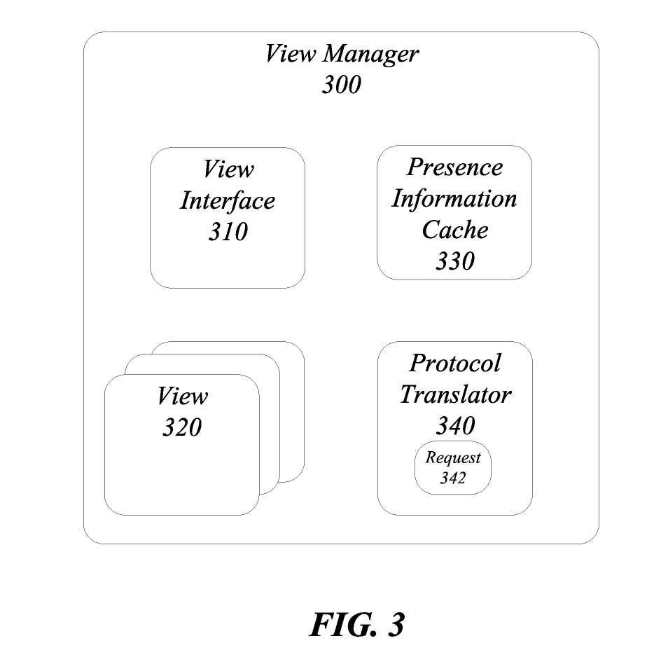

In various embodiments, view manager 220 may receive information from an application 132 executing on a client device 130 about what presence information is desired. The received information may constitute a view. View manager 220 may provide the view to the subscription manager 230. In an embodiment, view manager 220 may convert the view into a protocol-specific format to provide to subscription manager 230. In an embodiment, view manager 220 may convert the view into a protocol-neutral format to provide to subscription manager 230. View manager 220 may also receive presence information from subscription manager 230 and may pass the presence information to the requesting application 132. View manager 220 is described in further detail with respect to FIG. 3.

In various embodiments, subscription manager 230 may receive the view information from view manager 220 and may request the presence information described in the view from a presence server 120. Subscription manager 230 may be aware of and handle the communication with a presence server 120 according to any protocol-specific or server specific requirements to obtain the presence information. Subscription manager 230 may inform view manager 220 as to when requested presence information was or was not obtained, and may pass presence information back to view manager 220. Subscription manager 230 may, in an embodiment, not be aware of a view structure.

In various embodiments, web services server 210 may include user accounts 240. A user account 240 may be issued to an individual user to allow the user to access web services server 210. A user account 240 may include data about its user, such as a name, a password, an e-mail address, and so forth. In an embodiment, web services server 210 may authenticate a user who requests presence information using a user account 240 for that user.

FIG. 3 illustrates an embodiment of a view manager 300 to provide remote presence subscription. View manager 300 may be a representative embodiment of view manager 220. In various embodiments, view manager 300 may comprise various functional components, such as a view interface 310 and a protocol translator 340. The functions of view manager 300 may be implemented with more or other components and are not limited to this example.

In various embodiments, view manager 300 may include view interface 310. View interface 310 may provide a user interface that displays, to a user of client device 130, selection mechanisms that allow the user to indicate what presence information the user wants to receive. View interface 310 may be, for example, a graphical user interface (GUI), a form displayed in a web browser application, an applet, and so forth. In an embodiment, view interface 310 may be, instead, a stand-alone application executing on a client device 130, in communication with view manager 300. A selection may be through a touch gesture (e.g. tap) on a touch-sensitive input device, and/or through some other selection action (e.g. mouse, stylus, keyboard, selecting a menu option and so forth).

View interface 310 may, generally, provide one or more groups of remote users from which a configuring user may select. A group of remote users may include, for example, the configuring user's contacts from an e-mail application, a contact management application, an employee directory, a chat application, and so forth. In this context, “remote” may refer to an individual other than the configuring user. A remote user may also have a user account 240 on web services server 210, or may have an account on a presence server 120 that is visible to web services server 210. The embodiments are not limited to these examples. The configuring user may therefore select one or more remote users in view interface 310 for which he want presence information.

View interface 310 may also provide a set of options for what type of presence information can be obtained for user selection. Types of presence information may include, for example, an online availability status, contact information, an instant message availability status, a video chat availability status, a location, and so forth. The configuring user may select one or more types of presence information that he wants for the selected remote users.

View interface 310 may also provide a set of options for how frequently the presence information should be updated for the configuring user. Depending on the group of selected remote users, the type of presence information requested, or both, the frequency may be as often as with every change in presence information for any of the selected remote users. Selecting this kind of frequency may cause view manager 300 to request that the relevant presence server 120 push information to view manager 300 at every change. Frequency may be set to be scheduled, for example once an hour, once a day, and so forth. Scheduled updates may cause view manager 300 to poll the relevant presence server 120 for updates at the selected frequency.

The combination of selections for a group of remote users, type of presence information and frequency of updates, when complete and accepted by the configuring user, may be a discrete entity, such as a class object, a database entry, an object in a set, and so forth. The discrete entity is referred to herein as a view. In an embodiment, a client device 130, and an application 132, may generate multiple separate views. A view may be stored in views 320.

In an embodiment, views 320 may be consolidated or aggregated by view manager 300. For example, if more than one view 320 requests presence information for the same remote user “Joe Smith”, instead of requesting the presence information once for each view 320, view manager 300 may consolidate the many views into one view that includes all of the requested types of presence information for Joe Smith. When presence information returns from the subscription manager 230, it may then be distributed to the requesting clients according to the individual views 320.

In various embodiments, view manager 300 may include a presence information cache 330. Presence information cache 330 may be a memory store that holds some presence information received from one or more presence servers 120. In an embodiment, presence information cache 330 may be used to hold presence information for frequently requested remote users and/or for presence information that does not change frequently. When using presence information cache 330, view manager 300 may be able to provide requested presence information without having to query the presence servers 120.

In various embodiments, view manager 300 may include protocol translator 340. Protocol translator 340 may convert the information in a view 320 into a request 342 for presence information for a particular presence server 120. Protocol translator 340 may determine which presence server 120 has the requested presence information in a particular view 320, and may use the requested remote users and the types of presence information requested to construct the appropriate request 342 for the relevant presence server 120. Protocol translator 340 may submit the request to the relevant server at the interval specified in the view 320. In an embodiment, protocol translator 340 may provide the request 342 to view manager 300, or a separate component (not shown) to submit the request 342.

Protocol translator 340 may receive the presence information from the presence server 120 and may provide it to view manager 300 to return to the requesting client device 130. In an embodiment, protocol translator 340 may format the received presence information for the requesting application 132, or may provide the presence information unchanged.

In an embodiment, view manager 300 may monitor network conditions, the number of connections to a presence server 120, and/or how often the presence information for a view changes. When server loads are high, when a limit on the number of connections is reached, or when the presence information for a view rarely changes, view manager 300 may change the frequency of updates for a view from real-time updates to scheduled, or polled, updates. This may reduce server load, and free up connections to a presence server that may then be used for other views.

The components of view manager 300, such as view interface 310 and protocol translator 340 may be communicatively coupled via various types of communications media. The components 310 and 340 may coordinate operations between each other. The coordination may involve the uni-directional or bi-directional exchange of information. For instance, the components 310 and 340 may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

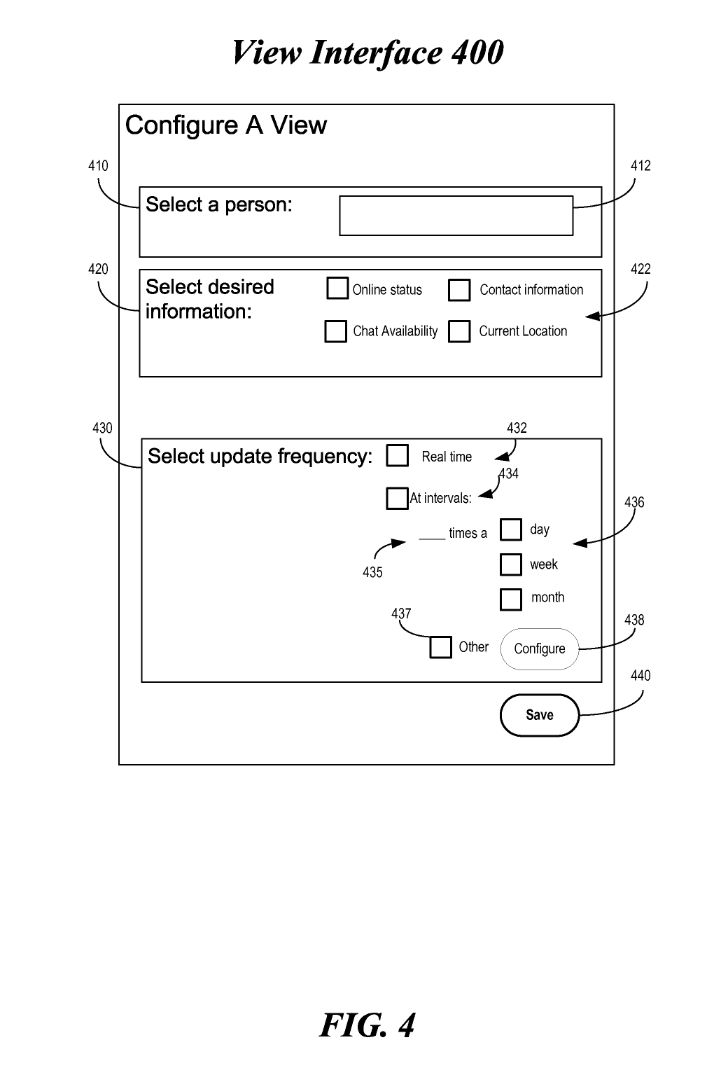

FIG. 4 illustrates an embodiment of a view interface 400. View interface 400 may be a representative embodiment of view interface 310. View interface 400 is one example, of many possible embodiments, of an interface through which a user can configure a view. View interface 400 may be displayed on a client device 130 within an application 132, as a web page displayed on a web browser application, and so forth.

In various embodiments, view interface 400 may include a remote user selection pane 410. Remote user selection pane 410 may include a selection field 412. In an embodiment, a user may use selection field 412 to indicate the remote user or users that she wishes to create a view for. Selection field 412 may be, for example, a text box in which the user can type a name, a drop down menu that lists the remote users from which the user may choose, and so forth. The embodiments are not limited to these examples.

In various embodiments, view interface 400 may include a type selection pane 420. Type selection pane 420 may provide options 422 for the types of presence information that can be requested in the view. The options 422 may be presented, for example, with selectable check boxes. Options 422 may also be presented as a drop-down menu, a dialog window separate from view interface 400, and so forth. The embodiments are not limited to these examples.

In various embodiments, view interface 400 may include a frequency selection pane 430. Frequency selection pane 430 may provide options for how often the requested information should be updated for the requesting user. The options may include a real-time option 432. Selecting real-time option 432 may cause the view to use a push model, where the relevant presence server 120 notifies view manager 220 when the selected presence information changes.

Other options may include, without limitation, an at intervals option 434. At intervals 434 may have sub-options to allow the user to specify the interval length. A number field 435 may allow the user to enter or select an integer that would indicate a number of times in a time period to update. The time period may be selected with time period options 436.

Other interval options may be selected with other option 437, and configured by selecting configure button 438. Configure button 438 may open a separate interface (not shown) to allow the user to specify an interval that is not represented elsewhere in the frequency selection pane 430. Other options may include, for example, specific days of the week, times of the day, or on the occurrence of an event. The embodiments are not limited to these examples.

When the user has made selections in view interface 400, selecting the save button 440 may cause the view to be saved as a view 320. The saved view may be associated with the user that saved the view, assuming that the user is somehow identified to view manager 300, for example, through a user account 240.

In an embodiment, view manager 220, 300 may assign an expiration date to a view 320. When a view 320 is about to expire, for example, on the following day, view manager 220, 300 may notify the user that created the view that it is about to expire. The notification may, for example, be sent as an e-mail message to the user, or as an alert window that opens when the communication-enabled application used to receive presence information is launched or in use. The user may have the option to renew the view, which may reset the expiration date. When a view is not renewed, the view expires, and is no longer serviced, freeing the server resources for other views to be serviced.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

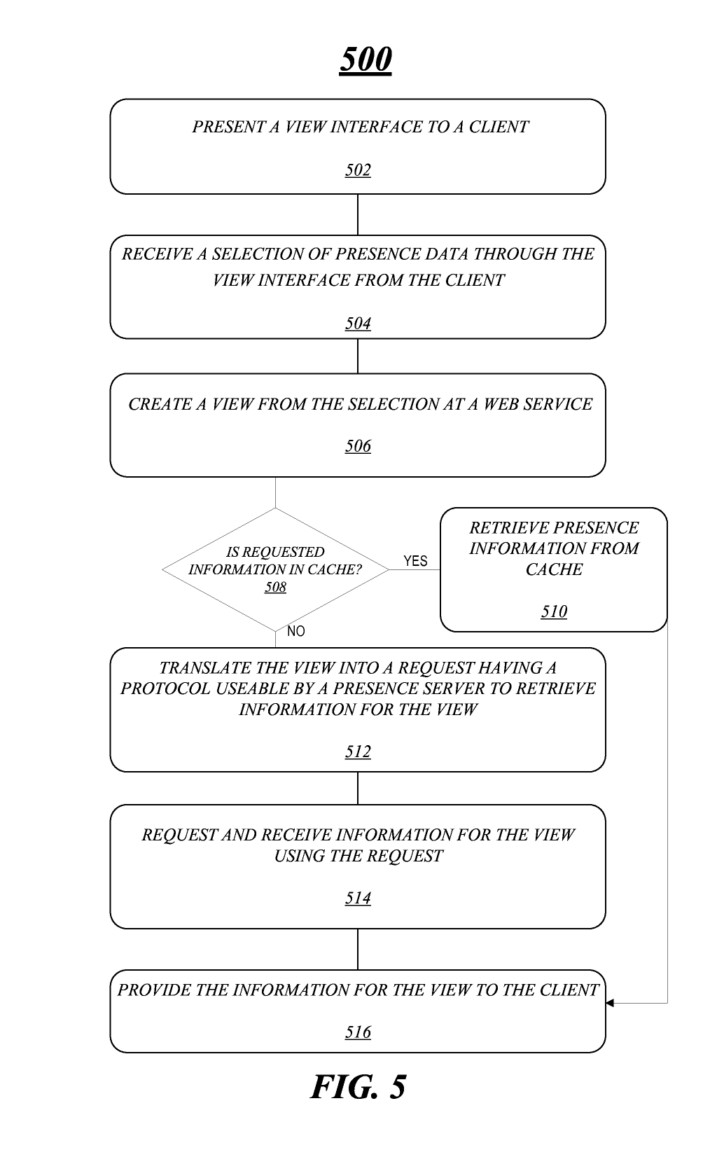

FIG. 5 illustrates an embodiment of a logic flow 500 to create and service a remote presence subscription. The logic flow 500 may be representative of some or all of the operations executed by one or more embodiments described herein.

In various embodiments, logic flow 500 may present a view interface to a client in block 502. For example, a client device 130 receive a control directive from a user to launch an application 132, which may communicate with web services server 110, 200. View manager 220, 300 may present a view interface 400 to application 132 in response to receiving a request to configure a view.

In various embodiments, logic flow 500 may receive a selection of presence data through the view interface from the client in block 504. For example, via control directives to client device 130, a user may select options in view interface 400 to select one or more remote users, one or more types of presence information, and an update frequency. When the selections are complete, the selections may be received by view manager 220, 300.

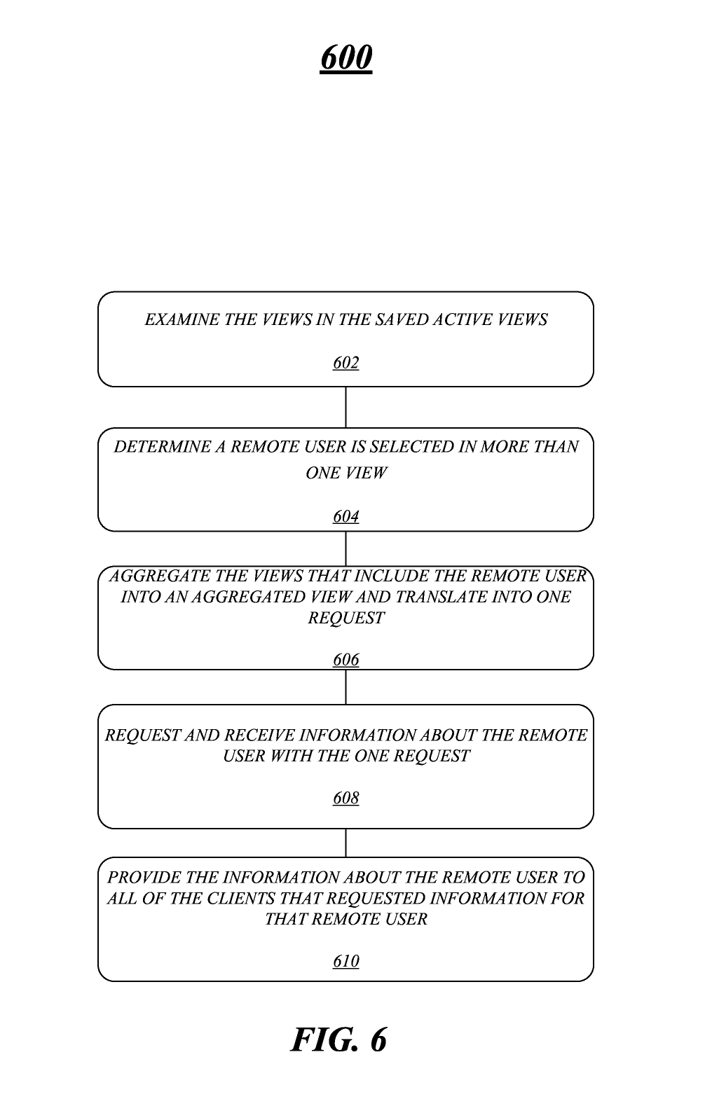

In various embodiments, logic flow 500 may create a view from the selection at a web service in block 506. For example, view manager 220, 300 may save the received selections as a view 320. In an embodiment, view manager 220, 300 may aggregate the new view with other views for the same selected remote user. An example of this process is illustrated in FIG. 6.

In various embodiments, logic flow 500 may check if the requested presence information is in the cache in block 508. For example, view manager 220, 300 may examine the contents of presence information cache 330 to determine whether the requested presence information is stored therein.

In various embodiments, logic flow 500 may retrieve the presence information from the cache in block 510, when the presence information is in the cache. Logic flow 500 may proceed to block 516, described below.

In various embodiments, logic flow 500 may translate the view into a request having a protocol useable by a presence server to retrieve information for the view in block 512, when the presence information is not in the cache. For example, protocol translator 340 may determine the relevant presence server 120, according to the selected remote users, and may determine a protocol used by the relevant server. Protocol translator 340 may then format a request 342 for the information in the view in the protocol used by the relevant presence server 120.

In various embodiments, logic flow 500 may request and receive the information for the view using the request in block 514. For example, subscription manager 230 may send the request 342 to the relevant presence server 120, which may return presence information 122 to view manager 220, 300.

In various embodiments, logic flow 500 may provide the information for the view to the client in block 516. For example, view manager 220, 300 may pass or forward the presence information 122 to the application 132 on the client device 130 that requested the presence information.

FIG. 6 illustrates an embodiment of a logic flow 600 to aggregate views. The logic flow 600 may be representative of some or all of the operations executed by one or more embodiments described herein.

In various embodiments, logic flow 600 may examine the views in the active saved views in block 602. For example, view manager 300 may inspect the selections within each view in views 320. In an embodiment, view manager 300 may inspect just the selected remote users. In an embodiment, view manager 300 may inspect both the selected remote users and the presence information requested for them.

In various embodiments, logic flow 600 may determine that a remote user is selected in more than one view in block 604. For example, view manager 300 may count the number of time each selected remote user appears in a view 320. A remote user may appear in multiple views 320, for example, when more than one requesting user has selected the remote user to be in a view, or when the same requesting user has included the selected remote user in more than one view.

In various embodiments, logic flow 600 may aggregate the views that include the remote user into an aggregated view and translate the aggregated view into one request in block 606. For example, for a given selected remote user that appears in more than one view 320, view manager 300 may also determine all of the presence information requested for that selected remote user from the different views. One view, for example, may request online availability, while another may request video chat availability, and still another may request contact information. View manager 300 may consolidate the views into one aggregated view for the given selected remote user that includes all of the requested presence information. The aggregated view may be translated into a request that subscription manager 230 can use to request information from a presence server 120 for that given selected remote user. This allows the web services server 110 to send only one request, rather than the three separate requests of the example, preserving connection resources for other requests.

In various embodiments, logic flow 600 may request and receive information about the remote user with the one request in block 608. For example, subscription manager 230 may transmit the request to a presence server 120. The presence server 120 may respond to the request and transmit the requested presence information 122 back to subscription manager 230.

In an embodiment, the various views 320 that are for the same remote user may request updates at different intervals. In such a case, the one request may be sent to the relevant presence server 120 at the most frequent of the different intervals.

In various embodiments, logic flow 600 may provide the presence information 122 to all of the client devices 130 and/or applications 132 that created views requesting the presence information for the given selected user in block 610. For example, view manager 300 may use the relevant views 320 to determine what presence information about the given selected remote user was requested in each view, and may provide that information to the client device 130 and/or application 132 that generated the view.

When a view 320 expires, view manager 300 may, if the expiring view is not renewed, delete the view from views 320. If the expiring view was part of an aggregated view, the aggregated view may be re-aggregated to remove the view components that the expired view added to the aggregated view.

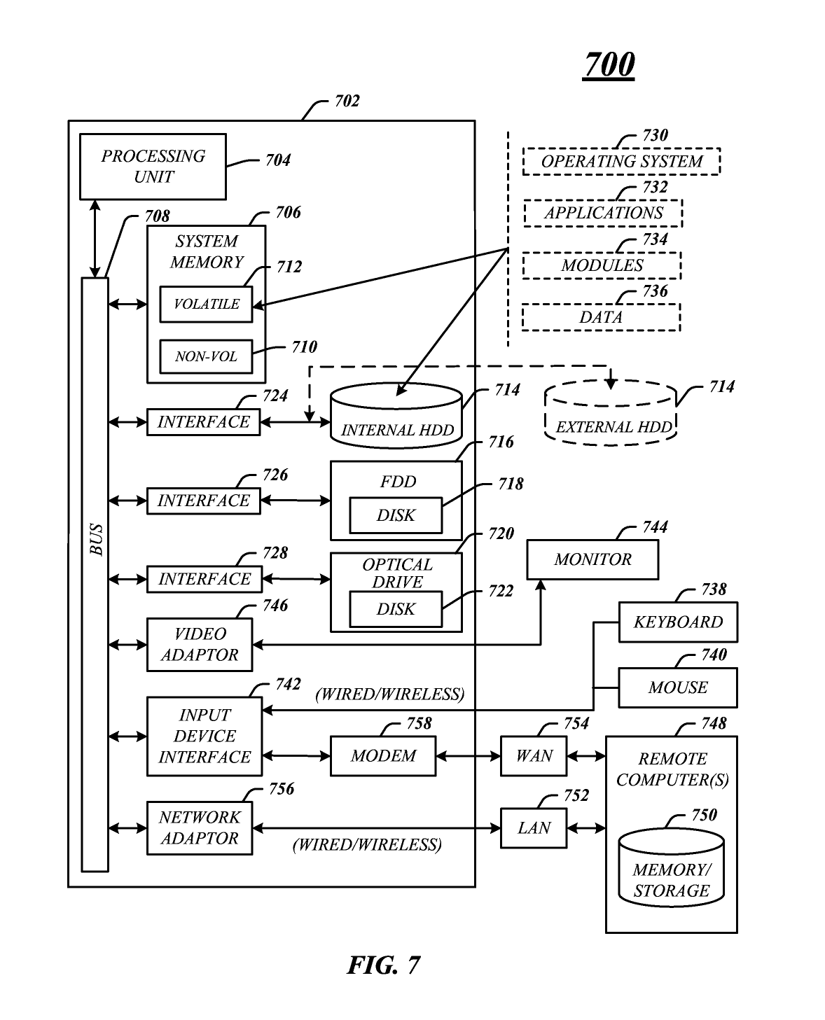

FIG. 7 illustrates an embodiment of an exemplary computing architecture 700 suitable for implementing various embodiments as previously described. The computing architecture 700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors. Dual microprocessors and other multi-processor architectures may also be employed as the processing unit 704. The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures.

The system memory 706 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media, including an internal hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable storage media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. The one or more application programs 732, other program modules 734, and program data 736 can include, for example, applications 132, view manager 220, 300, and subscription manager 230.

A user can enter commands and information into the computer 702 through one or more wire/wireless input devices, for example, a keyboard 738 and a pointing device, such as a mouse 740. Other input devices may include a microphone, an infra-red (IR) remote control, a joystick, a game pad, a stylus pen, touch screen, or the like. A camera and/or other sensing device may be used as an input device to record one or more users and capture motions and/or gestures made by users of a computing device. A sensing device may be further operative to capture spoken words, such as by a microphone and/or capture other inputs from a user such as by a keyboard and/or mouse. The sensing device may comprise any motion detection device capable of detecting the movement of a user. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

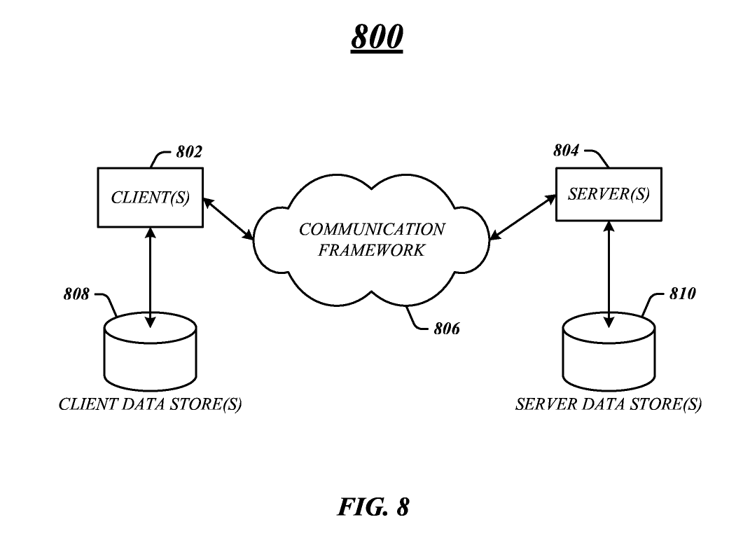

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, and so forth. The embodiments, however, are not limited to implementation by the communications architecture 800.

As shown in FIG. 8, the communications architecture 800 comprises includes one or more clients 802 and servers 804. The clients 802 may implement the client devices 130. The servers 804 may implement the server systems for web services server 110, 200 and presence servers 120. The clients 802 and the servers 804 are operatively connected to one or more respective client data stores 808 and server data stores 810 that can be employed to store information local to the respective clients 802 and servers 804, such as cookies and/or associated contextual information.

The clients 802 and the servers 804 may communicate information between each other using a communication framework 806. The communications framework 806 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 802 and the servers 804 may include various types of standard communication elements designed to be interoperable with the communications framework 806, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 802 and a server 804 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
presenting a view interface to a client device;
receiving a selection of presence data through the view interface from the client device;
creating a view from the selection at a web service;
translating the view into a request having a protocol useable by a presence server to retrieve information for the view;
requesting and receiving the information for the view using the request; and
providing the information for the view to the client.

2. The method of claim 1, further comprising:
assigning an expiration date to the view;
warning the client when the view is to expire; and
providing an option to renew the view.

3. The method of claim 1, wherein the selection of presence data includes a remote user, a type of presence information, or a frequency for updates.

4. The method of claim 3, further comprising aggregating a plurality of views.

5. The method of claim 4, wherein aggregating further comprises:
determining that a remote user is included in a plurality of views;
aggregating the plurality of views for the remote user into an aggregated view; and
translating aggregated view into one request.

6. The method of claim 3, further comprising changing a frequency of updates from real time updates to regular polling when:
a limit on a number of connections to a presence server is reached;
presence data for a person in a view changes at a frequency at or below a regular polling frequency; or
a load limit for a server is substantially reached.

7. The method of claim 1, further comprising:
caching information for the view; and
providing the cached information for the view to the client without requesting the information from the server.

8. The method of claim 1, further comprising creating a plurality of views for one client from a plurality of selections of people, categories of data of interest, and frequencies for updates.

9. One or more computer readable storage media comprising instructions that when executed cause a system to:
present a view interface to a requesting client device, the view interface providing selection mechanisms for selecting presence data including a remote user, a type of presence information or a frequency for updates;
receive a selection of presence data from the requesting client device;
create a view from the selection;
translate the view into a protocol useable by a presence server to retrieve information for the view;
request and receive the information for the view using the protocol; and
provide the received information for the view to the client device.

10. The one or more computer readable media of claim 9, further comprising instructions that when executed cause the system to:
assign an expiration date to the view;
warn the client device when the view is to expire;
provide an option to renew the view; and
assign new expiration date to the view when the view is renewed.

11. The one or more computer readable media of claim 9, further comprising instructions that when executed cause the system to aggregate a plurality of views into one aggregated view.

12. The one or more computer readable media of claim 11, further comprising instructions that when executed cause the system to:
determine that a remote user is selected in a plurality of views;
aggregate the plurality of views into an aggregated view for the remote user; and
translate the aggregated view into one aggregated request.

13. The one or more computer readable media of claim 12, further comprising instructions that when executed cause the system to provide the presence information received in response to the aggregated request to each of the client devices that created one of the plurality of views, according to the view created by the client device.

14. The one or more computer readable media of claim 9, further comprising instructions that when executed cause the system to change a frequency of updates from real time updates to regular polling when:
a limit on a number of connections to a presence server is reached;
presence data for a person in a view changes at a frequency at or below a regular polling frequency; or
a load limit for a server is substantially reached.

15. The one or more computer readable media of claim 9, wherein a name comprises cache presence information for the view.

16. An apparatus, comprising:
a processor circuit;
a memory communicatively coupled to the processor circuit; and
a view manager operative to execute on the processor circuit to create a view from a selection of presence data from a client device, translate the view into a protocol useable by a presence server to retrieve information for the view, request and receive the information for the view using the protocol, and provide the received information for the view to the client device.

17. The apparatus of claim 16, the view manager operative to:
assign an expiration date to the view;
warn the client device when the view is to expire;
provide an option to renew the view; and
assign new expiration date to the view when the view is renewed.

18. The apparatus of claim 16, wherein the selection of presence data includes a remote user, a a type of presence information, or a frequency for updates, the view manager further operative to:
determine that a remote user is selected in a plurality of views;
aggregate the plurality of views into an aggregated view for the remote user; and
translate the aggregated view into one aggregated request.

19. The apparatus of claim 18, the view manager further operative to provide the presence information received in response to the aggregated request to each of the client devices that created one of the plurality of views, according to the view created by the client device.

20. The apparatus of claim 16, the view manager further operative to change a frequency of updates from real time updates to regular polling when a limit on a number of connections to a presence server is reached, presence data for a person in a view changes at a frequency at or below a regular polling frequency, or a load limit for a server is substantially reached.
